(19) United States
(12) Patent Application Publication
(10) Pub. No.: US 2014/0109042 A1
(43) Pub. Date: Apr. 17, 2014

(54) METHOD AND A TOOL FOR AUTOMATICALLY GENERATING PROGRAM CODE FOR A COMPUTER PROGRAM

(71) Applicant: Sitecore A/S, Kobenhavn V (DK)

(72) Inventor: Jakob Hjort CHRISTENSEN, Kastrup (DK)

(73) Assignee: Sitecore A/S, Kobenhavn V (DK)

(21) Appl. No.: 14/051,928

(22) Filed: Oct. 11, 2013

Related U.S. Application Data
(60) Provisional application No. 61/713,280, filed on Oct. 12, 2012.

(51) Int. Cl. G06F 9/44

(52) U.S. Cl. CPC G06F 8/34
USPC 717/109

(57) ABSTRACT

A method and a tool for generating program code for a computer program are disclosed. A programmer types a code statement forming part of the program code. A code generation tool analyses said code statement. Based on said analysis, the code generation tool inspects a collection of code statements which have previously been generated, and suggests the next code statement for the program code, based on the inspection.

### FIELD OF THE INVENTION

The present invention relates to a method and a tool for automatically generating program code for a computer program. The method and the tool according to the invention aids programmers in generating program code with less errors and using fewer keystrokes than manually generated program code.

### BACKGROUND OF THE INVENTION

When programmers generate code manually there is some risk that logic mistakes or typing errors occur. Such errors may give rise to errors in the final program which may cause program failure or malfunction. Furthermore, the errors may be difficult to locate.

Various attempts have previously been made in order to reduce the risk of code errors as well as to reduce the required number of keystrokes performed by the programmer.

U.S. Pat. No. 8,245,186 discloses a system and a method for offering and applying source code modifications based upon a context of a user in a development environment. A code editor accepts user input comprising source code. Code snippets of sample source code are stored in a data source. A code completion tool monitors user actions and detects a triggering action in the monitored user actions. A code snippet associated with the triggering action is identified, and an option is offered representing the code snippet. In response to user selection of the option, the associated code snippet is inserted into the code editor and is automatically customized based upon the user context.

US 2004/0153995 discloses a software development tool. In one embodiment, a system includes an editor to assist in the development of source code for a computer program comprising a context analyser and a grammar analyser. The system also includes a completion module invoked without the need for any specific trigger event and operative to display a set of contextually valid identifiers and statements for completing the statement being input by the developer.

U.S. Pat. No. 7,562,344 discloses a system, method, and computer program product for providing real-time developer feedback. An analyser parses code entered by a user into an editor. The analyser searches a profile database for a developer profile of the user. In response to a hit resulting from the search of the developer profile, the analyser determines a frequency of occurrence of a construct type associated with the hit, identifies a cue assigned to the frequency of occurrence for the construct type, and delivers the cue to the computer. For instance, it may be determined whether the developer is writing code in an area where he/she commonly makes mistakes. If this is the case, an appropriate warning may be presented to the developer.

### DESCRIPTION OF THE INVENTION

It is an object of embodiments of the invention to provide a method for generating program code, in which the correctness of the generated program code is increased as compared to prior art methods.

It is a further object of embodiments of the invention to provide a method for generating program code, in which the risk of typing errors occurring in the generated program code is reduced as compared to prior art methods.

It is an even further object of embodiments of the invention to provide a method for generating program code, in which the number of keystrokes required by the programmer is reduced as compared to prior art methods.

It is an even further object of embodiments of the invention to provide a code generation tool, which aids a programmer in avoiding errors in the generated program code.

It is an even further object of embodiments of the invention to provide a code generation tool, which allows a programmer to reduce the number of required keystrokes when generating program code.

According to a first aspect the invention provides a method for generating program code for a computer program, the method comprising the steps of:
a programmer typing a code statement forming part of the program code,
a code generation tool analysing said code statement,
based on said analysis, the code generation tool inspecting a collection of code statements which have previously been generated, and
the code generation tool suggesting the next code statement for the program code, based on the inspection.

Thus, according to the first aspect, the invention relates to a method for generating program code for a computer program. As it will be described below, the program code is generated at least partly automatically.

In the present context the term ‘program code’ should be interpreted to mean a collection of executable computer instructions written in a suitable programming language, such as Java, C, C++, C#, etc. In the present context the term ‘computer program’ should be interpreted to mean a program code which, when translated into machine language, is capable of causing a desired behaviour of a machine, typically a computer.

According to the method of the first aspect of the invention, a programmer initially types a code statement forming part of the program code. In the present context the term ‘code statement’ should be interpreted to mean a complete line of program code for the computer program. The programmer is a human being who is skilled in generating program code for computer programs. The programmer may type the code statement via a keyboard connected to a computer device, such as a personal computer (PC), possibly connected to a server via a data network. As an alternative, other suitable input means may be used for typing the code statement, including, but not limited to, a mouse, a touch screen, an electronic pen, etc.

Thus, the step of the programmer typing a code statement is performed essentially in the manner a programmer would normally, in a manual manner, generate program code.

When the code statement has been typed in, a code generation tool analyses the code statement, which was typed by the programmer. Thereby the code generation tool obtains information about the code statement, such as, but not limited to, information about the nature of the code statement, the semantic construction of the code statement, variable names used in the code statement, etc. It should be noted that this step could also take place substantially simultaneously with the step of the programmer typing the code statement, i.e. the analysis may take place while the programmer types the code statement.

Based on the analysis, the code generation tool inspects a collection of code statements which have previously been generated. The code statements of the collection of code statements may have been generated by the programmer himself or herself. Alternatively or additionally, the code statements may have been generated by other programmers, e.g. the colleagues of the programmer, the collection of code statements may be at least partly generated from a library of code statements which has been obtained by the programmer, and/or the collection of code statements may include code statements of the code file which the programmer is currently working on. Since the code statements in the collection have been generated at a previous occasion, this step is performed on the basis of actual program code which is presumably operable and has a low occurrence of errors. Furthermore, to the extent that the code statements were generated by the programmer himself or herself, it represents how the programmer would typically generate the program code. The inspection may advantageously include searching for code statements which are identical or similar to the code statement which was typed by the programmer, in order to investigate which kind of code statement will typically follow such a code statement.

Thus, based on the inspection, the code generation tool suggests the next code statement for the program code. As mentioned above, the inspection may advantageously reveal code statements which are identical or similar to the code statement which was typed by the programmer, as well as the code statements which succeeded these code statements in the code which was previously generated by the programmer. The suggested next code statement may then be the code statement which most frequently succeeded the code statements which are identical or similar to the code statement which was typed by the programmer.

The suggested code statement therefore represents a code statement which is likely to be the correct next code statement for the program code. By suggesting the code statement to the programmer, a high correctness of the generated code is ensured. This is because the risk of typing errors is minimised, but also because the suggested code statement may be more likely to be correct than any code statement which the programmer may manually generate, since it has already been successfully generated. Furthermore, by allowing the programmer to simply select the suggested code statement, the number of keystrokes required by the programmer in order to produce the program code is reduced.

The method may further comprise the steps of:
the programmer accepting the suggested code statement, and
the code generation tool inserting the suggested code statement into the program code.

As described above, the number of keystrokes required by the programmer in order to generate the program code is thereby reduced as compared to a situation where the program code is generated completely manually by the programmer.

The step of the code generation tool suggesting the next code statement may comprise the code generation tool suggesting two or more alternative code statements. According to this embodiment, the programmer is presented with two or more alternatives. Thereby the correctness of the generated code is even further improved, since the probability that the correct code statement is suggested is increased when the programmer is presented with two or more alternatives, and is allowed to select the correct option from these alternatives.

The method may, in this case, further comprise the steps of:
the programmer selecting one of the suggested code statements, and
the code generation tool inserting the selected code statement into the program code.

According to this embodiment, the programmer selects the code statement among the suggested code statements which he or she recognises as the correct next code statement for the program code, as described above. The code generation tool then inserts this code statement into the program code, i.e. the entire next code statement is inserted by means of a single keystroke.

The method may further comprise the step of the code generation tool ranking the suggested code statements in accordance with a predetermined set of rules. According to this embodiment, the code generation tool, based on the predetermined set of rules, presents the code statement which is most likely to be the correct code statement at the top of a list of code statements. Thereby it is easy for the programmer to select this code statement, but it is still possible for the programmer to select one of the lower ranked code statements.

The step of ranking the suggested code statements may comprise ranking the code statements according to frequency of occurrence of the code statements in the collection of code statements. According to this embodiment, the highest ranked code statement is the one which appears most often as a succession to a code statement which is identical or similar to the code statement which was typed by the programmer. Alternatively, other ranking rules may be applied, such as the highest ranked code statement being the one which was used most recently, or the highest ranked code statement being the one which is considered to have the highest relevancy, e.g. based on an overall context of the program code, or the highest ranked code statement being the one which occurs after the code statement being most similar to the typed code statement, etc.

The step of the code generation tool suggesting the next code statement may be performed on the basis of a statistical analysis of the previously generated code statements. According to this embodiment, when the code statement which was typed by the programmer has been analysed, a statistical analysis is performed on the collection of code statements, on the basis of the analysis of the typed code statement. The statistical analysis may, e.g., include identifying code statements which are similar to the code statement which was typed by the programmer, including determining a degree of similarity reflecting an ‘overlap’ between the code statements, or how similar the code statements are. Alternatively or additionally, the statistical analysis may include identifying the most frequently occurring code statement. Other kinds of statistical analysis could also be contemplated.

It is an advantage that the collection of code statements contains code statements which have previously been generated, since the amount of code material may therefore be assumed to be sufficiently extensive to allow a meaningful statistical analysis to be performed.

The method may further comprise the step of adding the generated code statements to the collection of code statements. According to this embodiment, once a suggested code statement has been accepted and added to the code, the suggested code statement, as well as the code statement which was typed by the programmer and information that the suggested code statement follows the code statement which was typed by the programmer, is added to the collection of code statements, since these code statements now form part of code statements which have been generated by the programmer. Thereby the new program code forms part of the code statements which are inspected the next time the programmer types a code statement. Accordingly, the collection of code statements is continuously growing, as the programmer generates more program code, and thereby the statistical material is continuously improved, and the likelihood of suggesting a correct code statement is thereby improved.

When the generated code statements are added to the collection of code statements, the system may be regarded as a ‘self-learning’ system or an ‘artificial intelligence’ (AI) system, in the sense that the basis for suggesting code statements is continuously improved, and the system continuously learns from the experience of the programmer.

The step of the code generation tool analysing the code statement may comprise extracting a semantic construction of the code statement. According to this embodiment, the semantic context of the code statement, which was typed by the programmer, is analysed, thereby revealing the semantic construction of the code statement. For instance, the analysis may reveal that the code statement is a variable declaration, for instance:

v=1

In this case the variable name ‘v’ may not be important, but it may be important that a variable is declared, i.e. that ‘v’ is recognised as a variable. Accordingly, the analysis of the code statement in this case reveals that the code statement is of the form:

<variable>=1

Or even more generically, a code statement of the form ‘<variable>=<number>’, or even ‘<variable>=<assignment>’. Furthermore, in the case that two or more different variables occur in the code statement, the extracted semantic context may be relatively crude, regarding all the variables simply as ‘a variable’. As an alternative, a more complex semantic context could be extracted, in which the variables are regarded as different variables, e.g. ‘variable_A’, ‘variable_B’, etc. The desired level of complexity of the extraction of the semantic context may be selected.

The subsequent inspection of the collection of previous code statements may then include searching for code statements of this type, and investigating the semantic construction of the code statements which typically succeed this type of code statements. Thus, in the case that the collection of previous code statements includes the code statement ‘x=1’, this code statement would be identified as a code statement which is similar to the code statement (‘v=1’) which was typed by the programmer, because the two code statements have identical semantic constructions, though they are not identical, due to the difference in variable name. However, the semantic construction of a code statement is often very important with respect to how the next code statement should be constructed, and it therefore provides important information regarding what to search for in the collection of previous code statements.

Thus, the step of the code generation tool inspecting a collection of code statements may comprise searching for code statements having a semantic construction which is similar to the extracted semantic construction of the code statement which was typed by the programmer.

The step of the code generation tool analysing the code statement may further comprise extracting further information from the code statement, wherein said further information is not related to the semantic construction of the code statement, and the step of the code generation tool suggesting the next code statement may be performed using said further information.

Referring to the example above, the further information may, e.g., be or comprise information regarding the variable name of the declared variable. For instance, the inspection of the collection of previous code statements may reveal that code statements of the type:

<variable>=1

are often succeeded by a code statement of the type:

<variable>=<variable>+1

Thus, when it has been established that the variable name used in the code statement, which was typed by the programmer, is ‘v’, the code generation tool will know that the code statement to be suggested should be:

v=v+1,

rather than a code statement specifying another variable name.

Another example of a semantic construction which could be extracted is, e.g.:

R : record;
While (not eof(file)) {

R = file.NextRecord( );
If (r == null) break;
CustomProcedure(R);

}

In this example, several elements can be semantic, e.g. the procedure name and/or the variable name. Furthermore, the code appearing inside the ‘while’ statement could be considered as one semantic block.

The collection of code statements may be organised as an ordered tree data structure, where the code statements form nodes of the ordered tree data structure, and the step of the code generation tool inspecting the collection of code statements may comprise consulting the ordered tree data structure.

The ordered tree data structure may, e.g., be in the form of a so-called TRIE. When organising the code statements of the collection of code statements in an ordered tree data structure, an overview of which code statements are likely to succeed a given code statement can easily be obtained. The ordered tree data structure may further include information regarding the frequency of occurrence of various combinations of code statements, e.g. in the form of node counts of the ordered tree data structure.

It should be noted that the organisation of the collection of code statements described above could include several tree data structures. For instance, one tree data structure could be very general, regarding the semantic context of the code statements in a relatively crude manner, e.g. regarding all variables simply as <variable>. Other tree data structures could be more specific, e.g. distinguishing between different variables, e.g. regarding ‘variable_A’ and ‘variable_B’ as semantically distinct, in the case that two or more variables occur in a code statement.

The method may further comprise the step of the code generation tool suggesting one or more further subsequent code statements for the program code. According to this embodiment, the code generation tool is not only suggesting the next code statement. It also suggests the code statement succeeding the next code statement, and possibly one or more further code statements. Thus, an entire block of code statements may be suggested by the code generation tool. Naturally, the more code statements are suggested, the higher the risk that some of the suggested code statements are not correct. On the other hand, if a suggested code block is in fact correct, a lot of keystrokes and a lot of time will be saved for the programmer.

According to a second aspect the invention provides a code generation tool for generating program code for a computer program, the code generation tool comprising:
a data input device allowing a programmer to input code statements forming part of the program code,
an analysing engine arranged to analyse code statements being input via the data input device,
a code statement inspection device arranged to inspect a collection of code statements which have previously been generated, based on analysis performed by the analysing engine, and
a code generation engine arranged to suggest a next code statement, based on an output from the code statement inspection device.

It should be noted that a person skilled in the art would readily recognise that any feature described in combination with the first aspect of the invention could also be combined with the second aspect of the invention, and vice versa. Thus, the code generation tool according to the second aspect of the invention may advantageously be used for performing the method according to the first aspect of the invention.

As described above, the data input device may advantageously be or comprise a keyboard. Alternatively or additionally, the data input device may be or comprise a mouse, a touch screen, a pointing device and/or any other suitable kind of input device allowing the programmer to input a code statement.

According to the second aspect of the invention, a tool is provided for a programmer, which aids the programmer when he or she is generating program code. As described above with reference to the first aspect of the invention, the tool ensures that the number of keystrokes required by the programmer is reduced, and that the correctness of the generated code is increased, as compared to a situation where the programmer generates the entire program code manually.

The code generation tool may further comprise means for adding generated code statements to the collection of code statements. According to this embodiment, the collection of code statements is continuously updated and developed as the programmer generates program code, thereby improving the material on which the suggested code statement is based. Accordingly, when a new code statement is subsequently input by the programmer, the added code statements are also taken into account when the next code statement is suggested. Thereby the correctness of the suggested code statements is improved.

The collection of code statements may be organised as an ordered tree data structure, e.g. in the form of a so-called TRIE, where the code statements form nodes of the ordered tree data structure. This has already been described above.

The code generation tool may reside on a server. The server is typically accessible via a data network, such as the Internet or a Local Area Network (LAN). In the present context the term ‘server’ should be interpreted to cover a single device as well as two or more individual devices being interlinked in such a manner that they, to a programmer using the code generation tool, seem to act as a single device.

### BRIEF DESCRIPTION OF THE DRAWINGS

The invention will now be described in further detail with reference to the accompanying drawings in which

FIG. 1 is a diagrammatic view of a code generation tool according to an embodiment of the invention,

FIG. 2 is a flow diagram illustrating a method according to an embodiment of the invention, and

FIG. 3 is an ordered tree data structure representing a collection of code statements for use in a code generation tool and/or a method according to an embodiment of the invention.

### DETAILED DESCRIPTION OF THE DRAWINGS

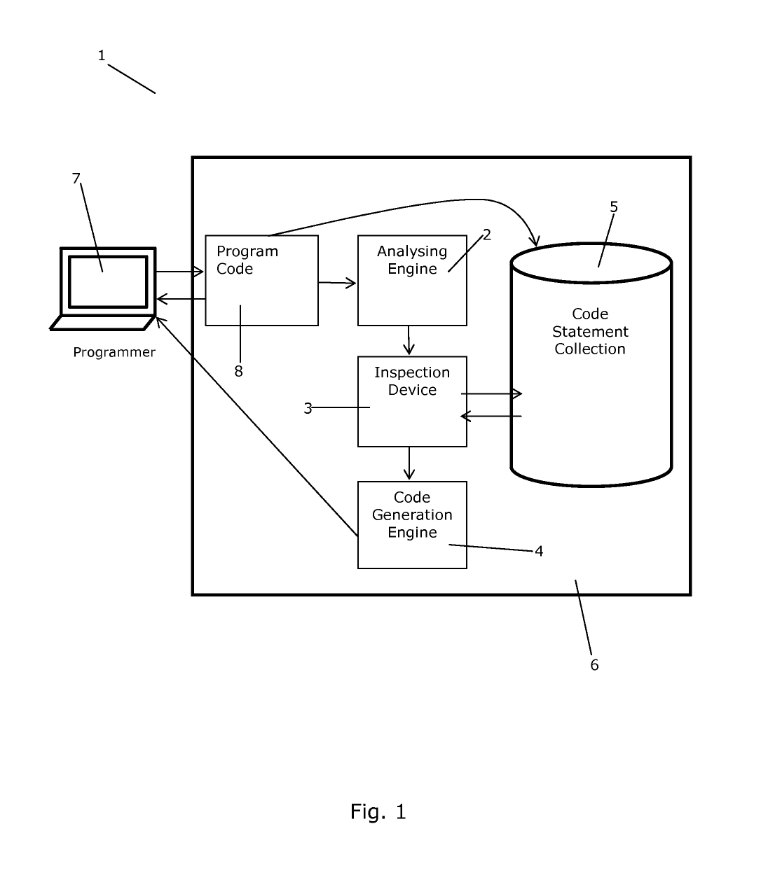

FIG. 1 is a diagrammatic view of a code generation tool 1 according to an embodiment of the invention. The code generation tool 1 comprises an analysing engine 2, a code statement inspection device 3, a code generation engine 4, and a code statement collection 5, all residing on a server 6. The code statement collection 5 contains a collection of code statements which have previously been generated. The code statements may have been generated by the programmer himself or herself. Alternatively or additionally, the code statements may have been generated by other programmers, e.g. the colleagues of the programmer, the collection of code statements may be at least partly generated from a library of code statements which has been obtained by the programmer, and/or the collection of code statements may include code statements of the code file which the programmer is currently working on.

The code generation tool 1 of FIG. 1 may be operated in the following manner. A programmer accesses the code generation tool 1, via a programmer device 7. In FIG. 1 the programmer device 7 is illustrated as a personal computer (PC), but it should be noted that the programmer device 7 could alternatively be a cell phone, a tablet, a TV, or any other suitable kind of programmer device allowing the programmer to access the code generation tool 1.

The programmer then types a code statement, via the programmer device 7. The code statement may advantageously be typed by means of a keyboard of the programmer device 7. Alternatively, other kinds of input devices may be used, such as a mouse, a touch screen, a pointing device, an electronic pen, etc.

The typed code statement is added to a program code 8 being generated. When the code statement has been typed in, the analysing engine 2 analyses the code statement. This may include extracting a semantic construction of the code statement, thereby obtaining information about the kind or nature of the code statement.

Based on the analysis, the code statement inspection device 3 inspects the collection of code statements 5. This may include searching for code statements being identical or similar to the code statement which was typed in by the programmer, e.g. in terms of the semantic construction of the code statement. The code statement inspection device 3 further investigates which code statements succeeded the code statements which are identified as identical or similar to the code statement, which was typed in by the programmer.

Based on the inspection, the code generation engine 4 generates a code statement and suggests the generated code statement as the next code statement of the program code. Thus, the suggested code statement is presented to the programmer, via the programmer device 7. The code generation engine 4 may present only one suggested code statement to the programmer, or it may present two or more alternatives to the programmer.

The programmer then reviews the suggested code statement(s), and if it is determined that one of the suggested code statement(s) is a correct code statement, i.e. it is the code statement which the programmer would normally generate manually as the next code statement of the program code 8, the programmer selects and accepts the correct code statement. The accepted code statement is then added to the program code 8. Thereby an entire code statement has been added to the program code 8 by means of a single keystroke, mouse click or the like. Accordingly, the number of keystrokes required by the programmer is minimised. Furthermore, the risk of typing errors in the program code 8 is significantly reduced. Finally, since the code statement collection 5 may reflect the previous behaviour and the experience of the programmer better than the programmer's memory, the suggested code statement is more likely to result in a correct program code, than a code statement generated manually by the programmer. Thus, the correctness of the generated program code 8 is increased.

When the suggested code statement has been added to the program code 8, the generated code statements are added to the collection of code statements 5. Preferably, the code statement typed by the programmer, the suggested and accepted code statement, as well as the fact that the accepted code statement succeeds the typed code statement, is added to the code statement collection 5. Thereby the collection of code statements 5 is continuously developed and improved as the programmer generates program code. This has been described in further detail above.

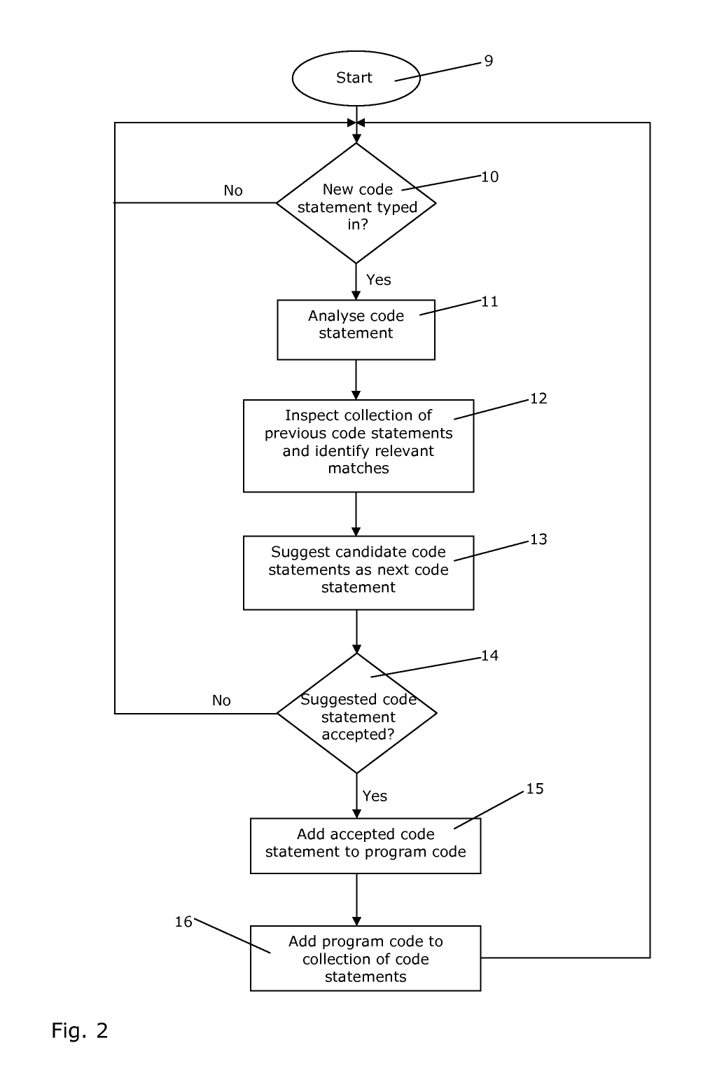

FIG. 2 is a flow diagram illustrating a method according to an embodiment of the invention. The method may, e.g., be performed by means of the code generation tool 1 illustrated in FIG. 1. The process is started at step 9. At step 10 it is investigated whether or not a new code statement has been typed in by a programmer. If this is not the case, the process is returned to step 10 until a new code statement is actually typed in.

When it is established, at step 10, that a new code statement has been typed in by the programmer, the typed code statement is analysed, at step 11. As described above, the analysis step may include extracting the semantic construction of the typed code statement.

Based on the analysis performed at step 11, a collection of code statements, which have previously been generated, is inspected at step 12. As described above, the inspection may include searching for code statement which are identical or similar to the typed code statement, and investigating which code statements typically succeed these code statements.

Based on the inspection performed at step 12, one or more candidate code statements is/are suggested as the next code statement, at step 13. The suggested code statement(s) is/are presented to the programmer. The code statement(s) being suggested is/are preferably selected in accordance with specific criteria. For instance, the code statements succeeding code statements with high similarity with the code statement which was typed by the programmer. Or the code statement(s) which occur(s) most often as succeeding the code statements which are similar to the code statement which was typed by the programmer. Or any other suitable criteria.

When a suggested code statement has been presented to the programmer, the programmer may either accept the suggested code statement, or choose not to accept the suggested code statement, at step 14. If the suggested code statement is not accepted, the process is returned to step 10, and the programmer types the next code statement manually.

If the suggested code statement is accepted by the programmer, the code statement is added to the program code, at step 15. Thus, an entire code statement is thereby added to the program code by a single keystroke or click by the programmer.

Next, at step 16, the generated program code is added to the collection of code statements. The suggested, and accepted, code statement, the code statement, which was initially typed by the programmer, as well as the fact that the suggested and accepted code statement succeeds the typed code statement, is added to the collection of code statements. Thereby this information is used the next time a new code statement is typed by the programmer, and the collection of code statements is inspected, as describes above. Thereby the collection of code statements is continuously developed and improved.

Finally, the process is returned to step 10, and the programmer types a new code statement.

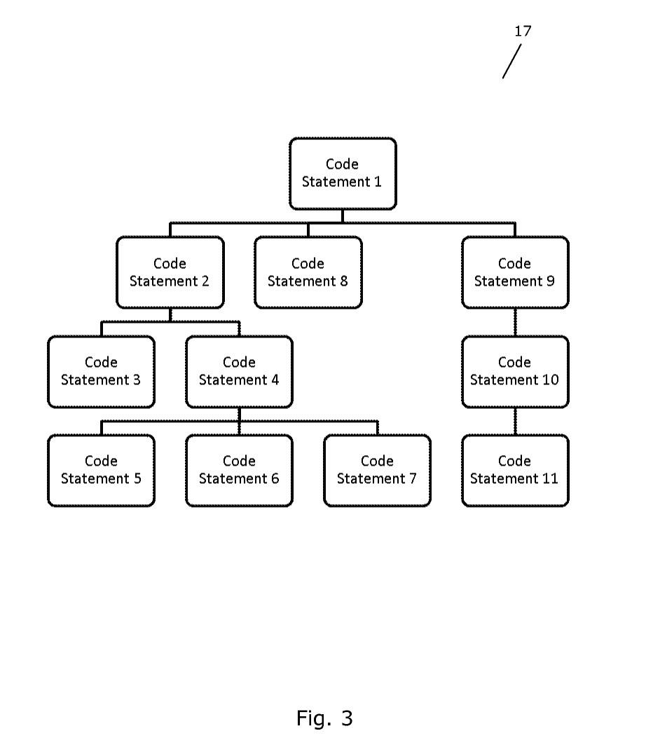

FIG. 3 is an ordered tree data structure 17, in the form of a so-called TRIE, illustrating code statements of a collection of code statements which have previously been generated. The ordered tree data structure 17 of FIG. 3 should not be regarded as illustrating all code statements of the collection of code statements, but merely as representing a part of the collection as will be apparent from the description below.

The nodes of the ordered tree data structure 17 are formed by code statements generated, e.g. by the programmer, and the positions of the code statements in the ordered tree data structure 17 represent the sequence of the generated code statements in program code.

In the program code illustrated by the ordered tree data structure 17, ‘code statement 1’ is initially generated. This is typically done by the programmer typing this code statement, but ‘code statement 1’ could, alternatively, be automatically generated by a code generation tool according to the present invention.

In the collection of code statements, ‘code statement 1’ was succeeded by three different code statements, i.e. ‘code statement 2’, ‘code statement 8’ or ‘code statement 9’. Thus, in some cases ‘code statement 1’ was succeeded by ‘code statement 2’, in other cases ‘code statement 1’ was succeeded by ‘code statement 8’, and in yet other cases ‘code statement 1’ was succeeded by ‘code statement 9’.

In the ordered tree data structure 17, no code statements succeed ‘code statement 8’. Thus, the collection of code statements does not contain further information regarding program code where ‘code statement 8’ succeeded ‘code statement 1’. This may be because ‘code statement 8’ represents the end of a program code, and that no code statement will naturally succeed ‘code statement 8’. As an alternative, it may be because no information regarding code statements which could succeed ‘code statement 8’ has been provided to the collection of code statements.

‘Code statement 2’ was succeeded by two different code statements, i.e. ‘code statement 3’ or ‘code statement 4’. Thus, in some cases the sequence of code statements was ‘code statement 1’—‘code statement 2’—‘code statement 3’, and in some cases the sequence of code statements was ‘code statement 1’—‘code statement 2’—‘code statement 4’. No code statements succeed ‘code statement 3’, and the remarks set forth above with reference to ‘code statement 8’ are equally applicable here.

‘Code statement 4’ was succeeded by three different code statements, i.e. ‘code statement 5’, ‘code statement 6’ or ‘code statement 7’.

‘Code statement 9’ was, in all cases, succeeded by ‘code statement 10’, and ‘code statement 10’ was, in all cases, succeeded by ‘code statement 11’. Thus, if the code statement which correctly succeeds ‘code statement 1’ is ‘code statement 9’, then it is highly likely that the two next code statements are ‘code statement 10’ and ‘code statement 11’, respectively. Thus, if it is decided that ‘code statement 9’ should be suggested to the programmer as the next code statement, in response to the programmer typing ‘code statement 1’, the code generation tool may as well suggest an entire code block, including ‘code statement 9’, ‘code statement 10’ and ‘code statement 11’ to the programmer, thereby allowing the programmer to complete three code statements of the program code by a single keystroke or click. This will be described further below.

Information regarding frequency of occurrence of the code statements could further be included in the ordered tree data structure 17. Thereby it can readily be derived from the ordered tree data structure 17 which code statement is most likely to be a correct code statement to succeed a typed code statement, and this code statement may then be suggested to the programmer, or be given the highest ranking in the case that two or more suggestions are presented. For instance, the ordered tree data structure 17 could contain the information that in 60% of the cases, ‘code statement 1’ was succeeded by ‘code statement 2’, in 30% of the cases by ‘code statement 8’, and in 10% of the cases by ‘code statement 9’. Thereby it can be derived that, given that ‘code statement 1’ is typed by the programmer, there is 60% chance that the next code statement is ‘code statement 2’, 30% chance that the next code statement is ‘code statement 8’, and 10% chance that the next code statement is ‘code statement 9’. Based on this information, the code generation tool may suggest ‘code statement 2’ as the next code statement. As an alternative, the code generation tool may suggest all three code statements, but rank them by providing ‘code statement 2’ with the highest ranking, ‘code statement 8’ with the second highest ranking, and ‘code statement 9’ with the lowest ranking.

The ordered tree data structure 17 of FIG. 3 provides an immediate overview of the sequence of code statements of program code which has previously been generated. This makes it easy to inspect the collection of code statements in response to a programmer typing a code statement, and in order to identify a probable next code statement for the program code. Furthermore, it is easy to determine whether or not it will be appropriate to suggest two or more alternative code statements to the programmer. It is also easy to determine whether or not it will be appropriate to suggest additional code statements, succeeding the next code statement of the program code. For instance, if it is determined, in response to the programmer typing ‘code statement 1’, that ‘code statement 9’ shall be suggested as the next code statement, then the ordered tree data structure 17 immediately reveals that it is appropriate to suggest an entire code block including the sequence ‘code statement 9’—‘code statement 10’—‘code statement 11’ to the programmer.

On the other hand, if it is determined that ‘code statement 2’ shall be suggested as the next code statement, then it may not be appropriate to suggest further succeeding code statements, because there are too many possible sequences of code statements which may be correct, and thereby the uncertainty of the correctness of the suggested code statements becomes so high that it becomes more a burden than a help to the programmer to suggest the further code statements. Therefore, in this case, it may be appropriate to only suggest ‘code statement 2’ as the next code statement.

1. A method for generating program code for a computer program, the method comprising the steps of:
a programmer typing a code statement forming part of the program code,
code generation tool analysing said code statement,
based on said analysis, the code generation tool inspecting a collection of code statements which have previously been generated, and
the code generation tool suggesting the next code statement for the program code, based on the inspection.

2. A method according to claim 1, further comprising the steps of:
the programmer accepting the suggested code statement, and
the code generation tool inserting the suggested code statement into the program code.

3. A method according to claim 1, wherein the step of the code generation tool suggesting the next code statement comprises the code generation tool suggesting two or more alternative code statements.

4. A method according to claim 3, further comprising the steps of:
the programmer selecting one of the suggested code statements, and
the code generation tool inserting the selected code statement into the program code.

5. A method according to claim 3, further comprising the step of the code generation tool ranking the suggested code statements in accordance with a predetermined set of rules.

6. A method according to claim 5, wherein the step of ranking the suggested code statements comprises ranking the code statements according to frequency of occurrence of the code statements in the collection of code statements.

7. A method according to claim 1, wherein the step of the code generation tool suggesting the next code statement is performed on the basis of a statistical analysis of the previously generated code statements.

8. A method according to claim 1, further comprising the step of adding the generated code statements to the collection of code statements.

9. A method according to claim 1, wherein the step of the code generation tool analysing the code statement comprises extracting a semantic construction of the code statement.

10. A method according to claim 9, wherein the step of the code generation tool inspecting a collection of code statements comprises searching for code statements having a semantic construction which is similar to the extracted semantic construction of the code statement which was typed by the programmer.

11. A method according to claim 9, wherein the step of the code generation tool analysing the code statement further comprises extracting further information from the code statement, wherein said further information is not related to the semantic construction of the code statement, and wherein the step of the code generation tool suggesting the next code statement is performed using said further information.

12. A method according to claim 1, wherein the collection of code statements is organised as an ordered tree data structure, where the code statements form nodes of the ordered tree data structure, and wherein the step of the code generation tool inspecting the collection of code statements comprises consulting the ordered tree data structure.

13. A method according to claim 1, further comprising the step of the code generation tool suggesting one or more further subsequent code statements for the program code.

14. A code generation tool for generating program code for a computer program, the code generation tool comprising:
a data input device allowing a programmer to input code statements forming part of the program code,
an analysing engine arranged to analyse code statements being input via the data input device,
a code statement inspection device arranged to inspect a collection of code statements which have previously been generated, based on analysis performed by the analysing engine, and
a code generation engine arranged to suggest a next code statement, based on an output from the code statement inspection device.

15. A code generation tool according to claim 14, further comprising means for adding generated code statements to the collection of code statements.

16. A code generation tool according to claim 14, wherein the collection of code statements is organised as an ordered tree data structure, where the code statements form nodes of the ordered tree data structure.

17. A code generation tool according to claim 14, wherein the code generation tool resides on a server.
